(19) United States
(12) Patent Application Publication
(10) Pub. No.: US 2026/0225585 A1
(43) Pub. Date: Aug. 6, 2026

(54) MANAGEMENT SYSTEM

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP); Kazuhito ESHIMA, Toyota-shi (JP)

(73) Assignee: TOYOTA JIDOSHA KABUSHIKI KAISHA, Toyota-shi (JP)

(21) Appl. No.: 19/406,853

(22) Filed: Dec. 2, 2025

(30) Foreign Application Priority Data
Jan. 20, 2025 (JP) 2025-007933

(51) Int. Cl. B60W 30/06; B60W 50/14; G07C 5/00

(52) U.S. Cl. CPC B60W 30/06; B60W 50/14; G07C 5/008; B60W 2556/45

(57) ABSTRACT

A management system manages automated valet parking of a vehicle in a parking lot. Upon receiving a request to start the automated valet parking of the vehicle from a user of the vehicle, the management system checks whether or not a state of the vehicle satisfies a start condition that permits the automated valet parking to start. When the state of the vehicle does not satisfy the start condition, the management system notifies the user of feedback information regarding the state of the vehicle.

### CROSS-REFERENCES TO RELATED APPLICATION

The present disclosure claims priority to Japanese Patent Application No. 2025-007933, filed on Jan. 20, 2025, the contents of which application are incorporated herein by reference in their entirety.

### TECHNICAL FIELD

The present disclosure relates to automated valet parking (AVP: Automated Valet Parking) of a vehicle in a parking lot.

### BACKGROUND ART

Patent Literature 1 discloses automated valet parking in a parking lot. A vehicle that supports the automated valet parking acquires route information from a parking lot system and autonomously travels along the acquired route.

### List of Related Art

Patent Literature 1: German Patent Application Publication No. 102012222562

### SUMMARY

Automated valet parking of a vehicle in a parking lot is considered. In order to start the automated valet parking, a state of the vehicle may be required to satisfy a predetermined condition. When the state of the vehicle does not satisfy the predetermined condition, it is not possible to start the automated valet parking. If the situation where the automated valet parking cannot be started continues, a user of the automated valet parking service may feel a sense of anxiety or impatience. There is a room for improvement in the case where the situation where the automated valet parking cannot be started occurs.

A first aspect relates to a management system that manages automated valet parking of a vehicle in a parking lot.

The management system includes one or more processors.

Upon receiving a request to start the automated valet parking of the vehicle from a user of the vehicle, the one or more processors check whether or not a state of the vehicle satisfies a start condition that permits the automated valet parking to start.

When the state of the vehicle does not satisfy the start condition, the one or more processors notify the user of feedback information regarding the state of the vehicle.

A second aspect relates to a management system that manages automated valet parking of a vehicle in a parking lot.

The management system includes one or more processors.

Upon receiving a request to start the automated valet parking of the vehicle from a user of the vehicle, the one or more processors check whether or not a state of the vehicle satisfies a start condition that permits the automated valet parking to start.

The vehicle has a specific component whose state is remotely controllable.

The start condition includes a specific start condition that the state of the specific component is required to satisfy for permitting the automated valet parking to start.

When the state of the specific component does not satisfy the specific start condition, the one ore more processors remotely control the state of the specific component to satisfy the specific start condition, automatically or with approval of the user.

According to the first aspect, it is checked whether or not the state of the vehicle satisfies the start condition that permits the automated valet parking to start. When the state of the vehicle does not satisfy the start condition, the user is notified of the feedback information regarding the state of the vehicle. Based on the feedback information, the user is able to actively take action so that the state of the vehicle satisfies the start condition. This facilitates the start of the automated valet parking. Alternatively, the user is able to recognize that the state of the vehicle is going to satisfy the start condition, based on the feedback information. In either case, the user's sense of anxiety or impatience is reduced when the situation where the automated valet parking cannot be started occurs.

According to the second aspect, it is checked whether or not the state of the vehicle satisfies the start condition that permits the automated valet parking to start. When the state of the specific component of the vehicle does not satisfy the specific start condition, the state of the specific component is remotely controlled so as to satisfy the specific start condition. This increases a possibility that the state of the vehicle automatically satisfies the start condition. Therefore, the user's sense of anxiety or impatience is reduced when the situation where the automated valet parking cannot be started occurs.

### BRIEF DESCRIPTION OF DRAWINGS

FIG. 1 is a conceptual diagram illustrating an overview of an automated valet parking system (AVP system);

FIG. 2 is a conceptual diagram for explaining an example of automated valet parking;

FIG. 3 is a conceptual diagram for explaining an AVP start request and an AVP start condition;

FIG. 4 is a block diagram for explaining a configuration example of a vehicle;

FIG. 5 is a flowchart showing an example of processing related to an AVP start request;

FIG. 6 is a conceptual diagram for explaining an outline of feedback information notification which is an example of an AVP start promoting process;

FIG. 7 is a flowchart showing an example of processing related to the feedback information notification;

FIG. 8 is a conceptual diagram for explaining an outline of vehicle state remote control which is another example of the AVP start promoting process;

FIG. 9 is a flowchart showing a first example of processing related to the vehicle state remote control;

FIG. 10 is a flowchart showing a second example of processing related to the vehicle state remote control;

FIG. 11 is a flowchart showing a third example of processing relating to the vehicle state remote control;

FIG. 12 is a block diagram showing an example of a configuration of a vehicle;

FIG. 13 is a block diagram showing an example of a configuration of a user terminal; and

FIG. 14 is a block diagram showing an example of a configuration of a back-end system.

### DETAILED DESCRIPTION

Embodiments of the present disclosure will be described with reference to the accompanying drawings. In the following description, automated valet parking may be referred to as “AVP”.

### 1 AUTOMATED VALET PARKING SYSTEM (AVP SYSTEM)

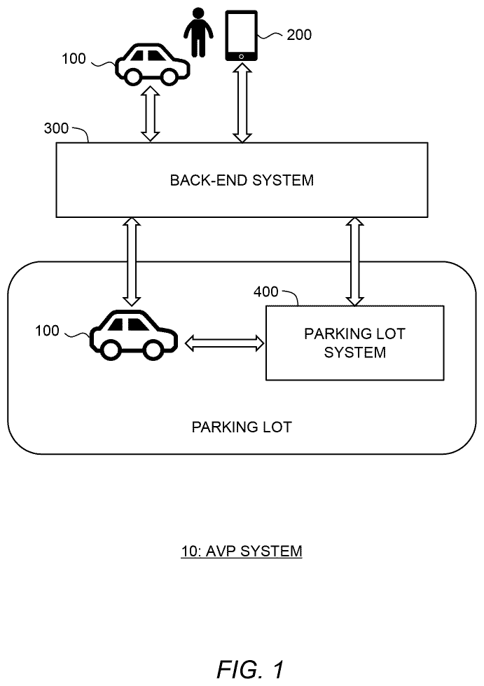

FIG. 1 is a conceptual diagram illustrating an overview of an AVP system 10 according to the present embodiment. The AVP system 10 is a system for the AVP in a parking lot. The AVP system 10 includes a vehicle 100, a user terminal 200, a back-end system 300, and a parking lot system 400.

The vehicle 100 is a target of the AVP in the parking lot. The vehicle 100 has a function of autonomously traveling at least in the parking lot.

The user terminal 200 is a terminal operated by a user of the AVP service, that is, a user of the vehicle 100. Examples of the user terminal 200 include a smartphone and a PC.

The back-end system 300 manages the AVP in one or more parking lots, users of the AVP service, the vehicles 100 being targets of the AVP, and the like. The parking lot system 400, which is an infrastructure system installed in a parking lot, manages the AVP in the parking lot. The back-end system 300 and the parking lot system 400 may be collectively referred to as a “management system.” The management system manages the AVP in the parking lot.

The vehicle 100 and the back-end system 300 can communicate with each other. For example, the vehicle 100 and the back-end system 300 communicate with each other using a mobile communication service. In the parking lot, the vehicle 100 and the parking lot system 400 can perform a wireless communication with each other. For example, the vehicle 100 and the parking lot system 400 perform a wireless communication with each other using a wireless LAN. Moreover, the user terminal 200 and the back-end system 300 can communicate with each other. For example, the user terminal 200 and the back-end system 300 communicate with each other using a mobile communication service. Further, the back-end system 300 and the parking lot system 400 may communicate with each other in a wired or wireless manner.

An example of a flow of a reservation of the AVP service is as follows. It is assumed that member information of the users is registered in advance in the back-end system 300. First, a user makes a reservation of the AVP. For example, the user operates the user terminal 200 to input ID information of the user, a desired parking lot, a desired date of use, a desired time of use (i. e, a scheduled entry time and a scheduled exit time), and the like. The user terminal 200 transmits reservation request information including the input information to the back-end system 300. The back-end system 300 executes reservation processing based on the reservation request information, and sends a reservation completion notification to the user terminal 200. In addition, the back-end system 300 provides reservation information to the parking lot system 400 of the reserved parking lot.

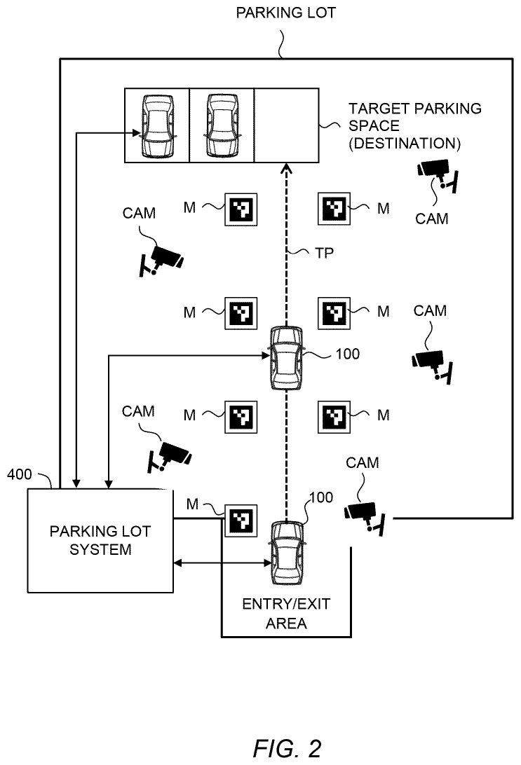

FIG. 2 is a conceptual diagram for explaining an example of the AVP in the parking lot.

The vehicle 100 recognizes a situation around the vehicle 100 by using a recognition sensor (for example, a camera) mounted on the vehicle 100. The vehicle 100 travels safely while recognizing the surrounding situation. A plurality of markers M (landmarks) may be arranged in the parking lot. The marker M is used for guiding the vehicle 100 in the parking lot. For example, the vehicle 100 acquires an image of the surroundings using the camera, and recognizes the marker M based on the image. Then, based on a result of recognition of the marker M, the vehicle 100 performs localization processing that estimates a position of the vehicle 100 in the parking lot with high accuracy. The vehicle 100 automatically travels in the parking lot based on the estimated vehicle position.

One or more infrastructure cameras CAM may be installed in the parking lot. The infrastructure camera CAM captures an image of the parking lot and acquires an image showing a situation of the parking lot. The parking lot system 400 communicates with the infrastructure camera CAM to acquire the image captured by the infrastructure camera CAM. The parking lot system 400 analyzes the image to detect the vehicle 100 shown in the image. Moreover, the parking lot system 400 estimates a position of the vehicle 100 shown in the image. Further, the parking lot system 400 manages the vehicle 100 in the parking lot based on the position of the vehicle 100. The parking lot system 400 may provide the vehicle 100 with the position information of the vehicle 100. The vehicle 100 may automatically travel in the parking lot based on the position information provided from the parking lot system 400.

An example of an entry process (check-in) is as follows. The vehicle 100 stops at an entry area. At the entry area, the user gets off the vehicle 100 and requests the entry by using the user terminal 200 or the like. The management system (i.e., at least one of the back-end system 300 and the parking lot system 400) conducts authentication of the user and the vehicle 100. Upon completion of the authentication, authority to operate the vehicle 100 is transferred from the user to the management system. The management system communicates with the vehicle 100 and activates the vehicle 100. Moreover, the parking lot system 400 allocates an available parking space to the vehicle 100. The allocated available parking space is a target parking space, that is, a destination for the vehicle 100 at the time of the entry. Further, the parking lot system 400 sets a travel path TP (a target trajectory) from the entry area to the target parking space in the parking lot. The parking lot system 400 sends an entry instruction to the vehicle 100. The entry instruction includes information on the target parking space and the travel path TP. In response to the entry instruction, the vehicle 100 automatically travels to the target parking space along the travel path TP. That is, the vehicle 100 automatically travels so as to follow the travel path TP based on the vehicle position. Then, the vehicle 100 is automatically parked in the target parking space. Upon completion of the parking, the management system instructs the vehicle 100 to stop the operation.

An example of an exit process (check-out) is as follows. The user requests the exit by using the user terminal 200 or the like. The management system communicates with the vehicle 100 and activates the vehicle 100. At the time of exit, a designated exit area is a destination for the vehicle 100. The parking lot system 400 sets a travel path TP (a target trajectory) from the parking space to the exit area in the parking lot. The parking lot system 400 sends an exit instruction to the vehicle 100. The exit instruction includes information on the designated exit area and the travel path TP. In response to the exit instruction, the vehicle 100 automatically travels to the exit area along the travel path TP. That is, the vehicle 100 automatically travels so as to follow the travel path TP based on the vehicle position. Then, the vehicle 100 automatically stops the vehicle 100 in the exit area. The authority to operate the vehicle 100 is transferred from the management system to the user. The user gets on the vehicle 100. The vehicle 100 starts moving to a next destination.

### 2. AVP START REQUEST AND AVP START CONDITION

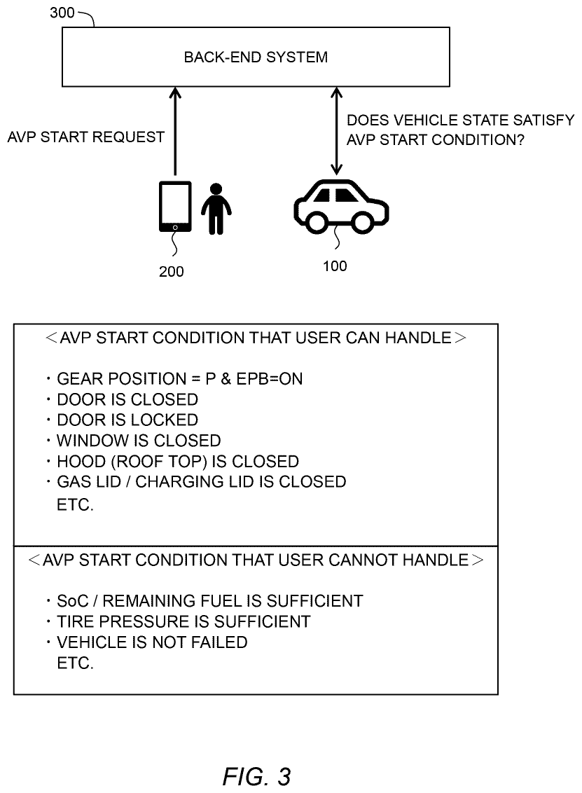

FIG. 3 is a conceptual diagram for explaining an AVP start request and an AVP start condition. To start an AVP of the vehicle 100 in the parking lot, the user requests an AVP start. For example, at the entry area, the user gets off the vehicle 100 and operates the user terminal 200 or the like to request the AVP start. For example, the user opens an AVP application on the user terminal 200. An “AVP start” button is displayed on a display of the user terminal 200. The user taps the “AVP start” button, and an AVP start request is sent from the user terminal 200 to the back-end system 300.

At the start of the AVP, it is not preferable that a door, a window or the like of the vehicle 100 (a target vehicle) is open. Therefore, upon receiving the AVP start request, the back-end system 300 communicates with the vehicle 100 to check (determine) whether or not a state of the vehicle 100 satisfies a predetermined AVP start condition. It can be said that the AVP start condition is a condition for permitting the start of the AVP of the vehicle 100 in the parking lot. The AVP start condition is predetermined, and the back-end system 300 holds information of the AVP start condition.

The AVP start condition includes, for example, the following items.
IG-OFF
Gear position is “P (Parking)”, and EPB (Electric Parking Brake) is ON.
Door is closed. Here, examples of the door include a side door and a back door (a door of a trunk).
Door is locked.
Window is closed.
Hood (roof top) is closed.
Gas lid/charging lid is closed.

These items can be manually handled by the user.

The AVP start condition may further include the following items that the user cannot handle.
SoC/remaining fuel is sufficient.
Tire pressure is sufficient.
Vehicle is not failed.

The state of the vehicle 100 related to the AVP start condition is hereinafter referred to as a “check target vehicle state”. Upon receiving the AVP start request, the back-end system 300 checks whether or not the check target vehicle state satisfies the AVP start condition. For this purpose, the back-end system 300 needs to acquire information on the check target vehicle state from the vehicle 100.

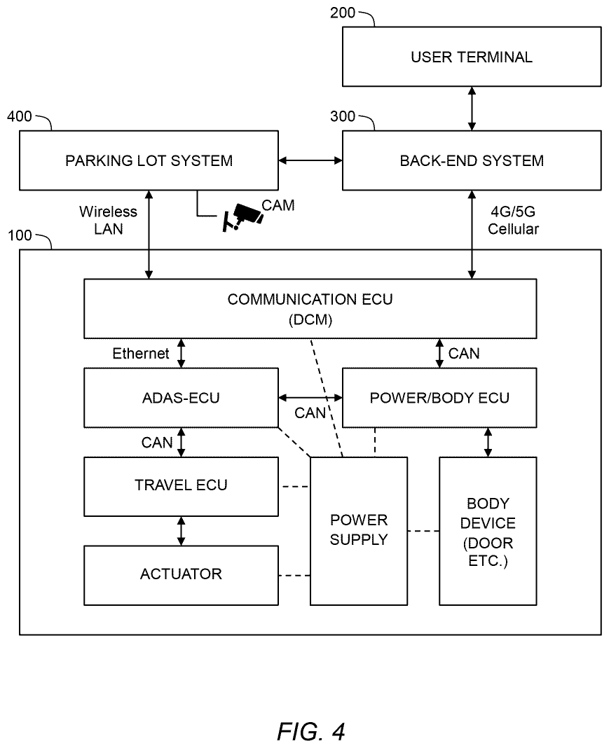

FIG. 4 is a block diagram for explaining a configuration example of the vehicle 100. The vehicle 100 includes a power supply, an actuator (travel device), a body

device, and the like. Examples of the body device include a door, a window, a light, a mirror, a wiper, a hood (roof top), a gas lid, a charging lid, and the like. The vehicle 100 further includes a communication ECU (Electronic Control Unit), an ADAS-ECU, a travel ECU, and a power/body ECU.

The communication ECU controls communication with the back-end system 300 and the parking lot system 400 (e.g., cellular communication control, wireless LAN communication control). The communication ECU is also referred to as a data communication module (DCM).

The ADAS-ECU controls automated driving in the AVP. The ADAS-ECU manages the state of the vehicle 100 during the AVP. The ADAS-ECU has a planner function. The ADAS-ECU calculates a control amount.

The travel ECU controls travel of the vehicle 100. More specifically, the travel ECU controls an operation of the actuator in accordance with the control amount calculated by the ADAS-ECU. The travel ECU includes a motion manager.

The power/body ECU performs power supply control and manages a power supply state. Moreover, the power/body ECU controls the body devices such as a door, a window, a hood, a light, a mirror, and the like, and manages states of the body devices. The state of each body device is recognized by a sensor provided in each body device.

The communication ECU and the ADAS-ECU are connected to each other via, for example, Ethernet (registered trademark). The other ECUs are connected to each other via, for example, a controller area network (CAN).

Even when the vehicle 100 is in the IG-OFF state, the communication ECU and the power/body ECU are in the standby state. Therefore, even when the vehicle 100 is in the IG-OFF state, the communication ECU and the power/body ECU are able to respond to an inquiry from the back-end system 300. More specifically, the back-end system 300 requests the vehicle 100 to provide information on the check target vehicle state, in order to check whether or not the check target vehicle state satisfies the AVP start condition. The communication ECU of the vehicle 100 accepts the request from the back-end system 300. The communication ECU transfers the request to the power/body ECU. The power/body ECU acquires current states of the power supply and the body devices of the vehicle 100, that is, acquires the information on the check target vehicle state. The power/body ECU returns the information on the check target vehicle state to the communication ECU. Further, the communication ECU returns the information on the check target vehicle state to the back-end system 300.

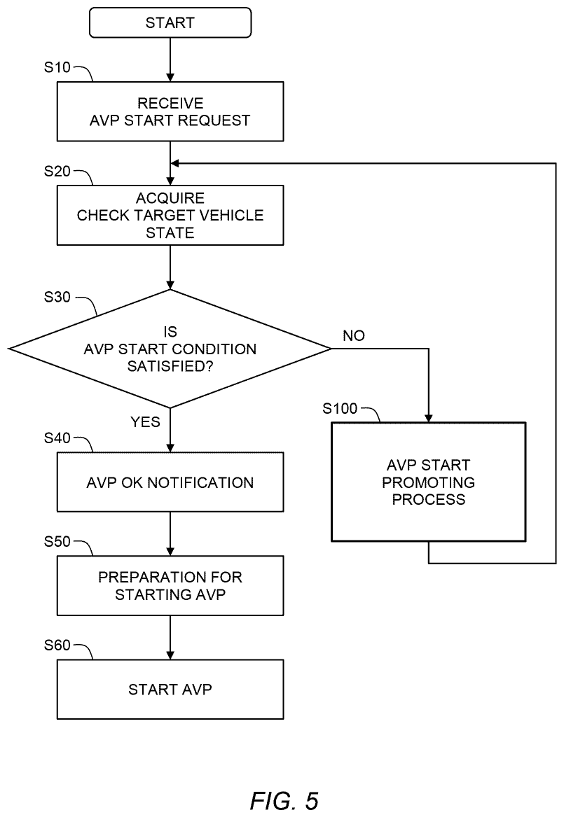

FIG. 5 is a flowchart showing an example of processing related to the AVP start request.

In Step S10, the back-end system 300 receives the AVP start request from the user. More specifically, the user operates the user terminal 200 or the like to request the AVP start. The user terminal 200 sends the AVP start request to the back-end system 300. The back-end system 300 receives the AVP start request from the user terminal 200.

In Step S20, the back-end system 300 communicates with the vehicle 100 and acquires the information on the check target vehicle state from the vehicle 100. More specifically, the back-end system 300 requests the vehicle 100 to provide the information on the check target vehicle state. In response to the request, the vehicle 100 acquires the information on the check target vehicle state and returns it to the back-end system 300.

In Step S30, the back-end system 300 checks whether or the check target vehicle state satisfies the AVP start condition. When the check target vehicle state satisfies the AVP start condition (Step S30; Yes), the processing proceeds to Step S40.

In Step S40, the back-end system 300 notifies the user that “AVP is possible”. More specifically, the back-end system 300 transmits an AVP OK notification to the user terminal 200. The user terminal 200 presents the AVP OK notification to the user. After that, the processing proceeds to Step S50. It should be noted that the Step S40 may be omitted.

### In Step S50, the Back-end System 300 Prepares for Starting the Avp.

More specifically, the back-end system 300 transmits a wake-up request to the vehicle 100 (i.e., the target vehicle) through communication. In response to the wake-up request, the communication ECU transmits an activation command to the power/body ECU. The power/body ECU turns on the power supply of the vehicle 100. As a result, the ADAS-ECU, the travel ECU, and the like are activated. The power/body ECU transmits information on the power supply state (i.e., activation completed) to the ADAS-ECU. The ADAS-ECU transmits information on the vehicle state including the power supply state to the communication ECU. The communication ECU transmits the vehicle state information to the back-end system 300. The back-end system 300 transmits the vehicle state information to the parking lot system 400.

The parking lot system 400 provides the back-end system 300 with connection information. The connection information includes an SSID of the parking lot system 400. The back-end system 300 provides the vehicle 100 with the connection information regarding the parking lot system 400 via communication. The vehicle 100 requests the parking lot system 400 to establish communication connection based on the connection information (SSID). The vehicle 100 and the parking lot system 400 perform mutual authentication using a certificate. Then, a wireless communication between the vehicle 100 and the parking lot system 400 is established.

After the communication is established, the parking lot system 400 instructs the vehicle 100 to perform a predetermined action. Examples of a visible action include turning on a light, flashing a light, flashing a blinker, operating a wiper, opening and closing a door, opening and closing a window, opening and closing a door mirror, opening and closing an engine hood, and so forth. Examples of an audible action include sounding a horn, driving an engine, and so forth. The ADAS-ECU of the vehicle 100 receives the action instruction via the communication ECU. In response to the action instruction, the ADAS-ECU instructs the power/body ECU to perform the predetermined action. The power/body ECU controls the body device to perform the predetermined action in accordance with the action instruction. For example, the power/body ECU flashes the blinker. The parking lot system 400 uses the infrastructure camera CAM or the like to recognize a vehicle that performs the predetermined action. The parking lot system 400 identifies a vehicle that has performed the predetermined action as the vehicle 100 (i.e., the target vehicle). The parking place system 400 localizes the vehicle 100 (i.e., the target vehicle).

When the preparation for staring the AVP is completed, the AVP system 10 starts the AVP of the vehicle 100 (i.e., the target vehicle) in Step S60.

On the other hand, when the check target vehicle state does not satisfy the AVP start condition (Step S30; No), it is not possible to start the AVP of the vehicle 100. However, simply rejecting the AVP start request from the user is unfriendly to the user. Moreover, if the situation where the AVP cannot be started continues, the user may feel a sense of anxiety or impatience. There is a room for improvement in the case where the situation where the AVP cannot be started occurs. A user-friendly response is desired in the case where the situation where the AVP cannot be started occurs.

In view of the above, according to the present embodiment, when the check target vehicle state does not satisfy the AVP start condition (Step S30; No), the back-end system 300 executes an “AVP start promoting process” for promoting the AVP start (Step S100). The AVP start promoting process according to the present embodiment will be described in detail below.

### 3. AVP START PROMOTING PROCESS

The AVP start promoting process (Step S100) includes at least one of “feedback information notification” and “vehicle state remote control”. Hereinafter, the feedback information notification and the vehicle state remote control will be described in detail.

### 3-1. Feedback Information Notification

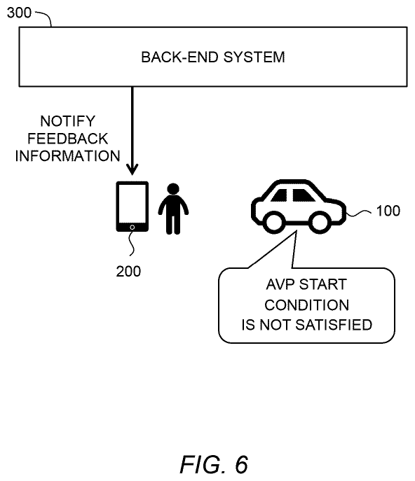

FIG. 6 is a conceptual diagram for explaining an outline of the feedback information notification. When the check target vehicle state of the vehicle 100 does not satisfy the AVP start condition, the back-end system 300 notifies the user of feedback information INF regarding the check target vehicle state. More specifically, the back-end system 300 communicates with the user terminal 200 and transmits the feedback information INF regarding the check target vehicle state to the user terminal 200. The user terminal 200 presents the feedback information INF received from the back-end system 300 to the user.

For example, the feedback information INF regarding the check target vehicle state indicates that the check target vehicle state does not satisfy the AVP start condition. For example, the feedback information INF may indicate how the check target vehicle state does not satisfy the AVP start condition (e.g., “door is open”, “window is open”, etc.). As another example, the feedback information INF may indicate how to change the check target vehicle state to satisfy the AVP start condition (e.g., “close the door”, “close the window”, etc.). Based on such the feedback information INF, the user is able to modify the check target vehicle state by himself or herself so as to satisfy the AVP start condition. In other words, based on such the feedback information INF, the user is able to actively take action so that the check target vehicle state satisfies the AVP start condition. This facilitates the start of the AVP. Such the feedback information INF can also be referred to as “assist information” for assisting the user's positive action.

It should be noted that the feedback information INF may include information other than the assist information. For example, the feedback information INF regarding the check target vehicle state may indicate that the check target vehicle state is going to satisfy the AVP start condition. Examples of such the feedback information INF will be described later in Section 3-2.

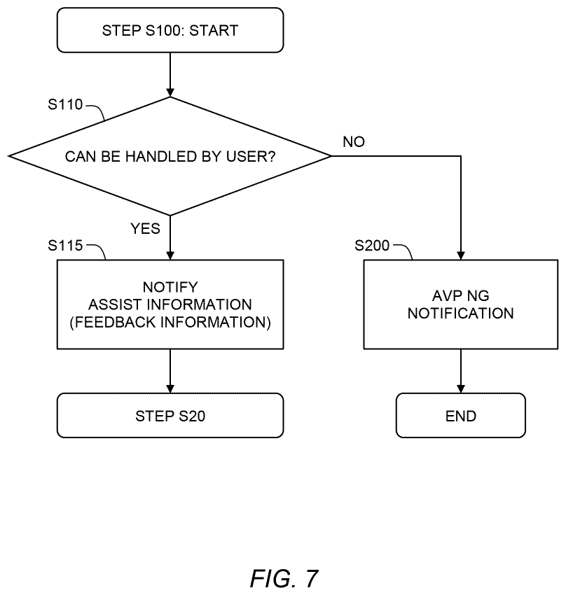

FIG. 7 is a flowchart showing an example of the processing related to the feedback information notification in Step S100.

Some AVP start conditions may not be able to be handled by the user (see FIG. 3). In Step S110, the back-end system 300 determines whether the AVP start condition that is not satisfied this time can be handled by the user. If all the AVP start condition that is not satisfied this time can be handled by the user (Step S110; Yes), the processing proceeds to Step S115. Otherwise (Step S110; No), the processing proceeds to Step S200.

In Step S115, the back-end system 300 notifies the user of the assist information (the feedback information INF). More specifically, the back-end system 300 transmits the assist information to the user terminal 200. The user terminal 200 presents the assist information received from the back-end system 300 to the user. It is expected that the user actively takes action, based on the assist information, so that the check target vehicle state satisfies the AVP start condition. After Step S115, the processing returns to Step S20 described above.

In Step S200, the back-end system 300 rejects the AVP start request and notifies the user that the AVP is not possible (AVP NG notification).

As described above, when the check target vehicle state of the vehicle 100 does not satisfy the AVP start condition, the user is notified of the feedback information INF regarding the check target vehicle state. Based on the feedback information INF, the user is able to actively take action so that the check target vehicle state satisfies the AVP start condition. This facilitates the start of the AVP. Alternatively, the user is able to recognize that the check target vehicle state is going to satisfy the AVP start condition, based on the feedback information INF. In either case, the user's sense of anxiety or impatience is reduced when the situation where the AVP cannot be started occurs.

### 3-2. Vehicle State Remote Control

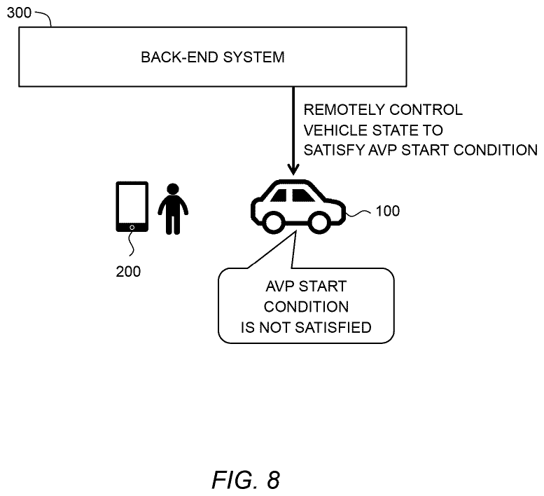

FIG. 8 is a conceptual diagram for explaining an outline of the vehicle state remote control. When the check target vehicle state of the vehicle 100 does not satisfy the AVP start condition, the back-end system 300 remotely controls the check target vehicle state so as to satisfy the AVP start condition as much as possible. For example, when a door of the vehicle 100 is open and the door is remotely controllable, the back-end system 300 remotely controls the door of the vehicle 100 to close. This increases the possibility that the check target vehicle state satisfies the AVP start condition without the user's positive action.

The vehicle 100 has various components related to the AVP start condition. In particular, among the power supply and the body devices of the vehicle 100, a component whose state is remotely controllable is hereinafter referred to as a “specific component”. The state of the specific component can be controlled by the power/body ECU (see FIG. 4). The back-end system 300 is able to communicate with the vehicle 100 to remotely control the state of the specific component via the communication ECU and the power/body ECU of the vehicle 100. The AVP start condition includes a “specific start condition” that the state of the specific component is required to satisfy for permitting the AVP to start. For example, the specific component is a door, and the specific start condition is that the door is closed. As another example, the specific component is the power supply, and the specific start condition is IG-OFF.

It should be noted that the specific component may vary depending on a vehicle type and customization. The back-end system 300 may recognize the specific component of the vehicle 100 based on vehicle type information of the vehicle 100. Alternatively, the back-end system 300 may recognize the specific component of the vehicle 100 based on information directly indicating the specific component.

The back-end system 300 checks whether or not the check target vehicle state of the vehicle 100 satisfies the AVP start condition. When the state of the specific component does not satisfy the specific start condition, the back-end system 300 remotely controls the state of the specific component so as to satisfy the specific start condition. The back-end system 300 may automatically remotely control the state of the specific component to satisfy the specific start condition. Alternatively, the back-end system 300 may remotely control the state of the specific component so as to satisfy the specific start condition, with approval of the user.

As described above, when the state of the specific component of the vehicle 100 does not satisfy the specific start condition, the state of the specific component is remotely controlled so as to satisfy the specific start condition. This increases the possibility that the check target vehicle state of the vehicle 100 automatically satisfies the AVP start condition. Therefore, the user's sense of anxiety or impatience is reduced when the situation where the AVP cannot be started occurs. Moreover, even if the user does not actively take action, the check target vehicle state is highly likely to satisfy the AVP start condition. Therefore, convenience for the user is improved.

Hereinafter, a variety of examples of the processing related to the vehicle state remote control will be described.

### 3-2-1. First Example

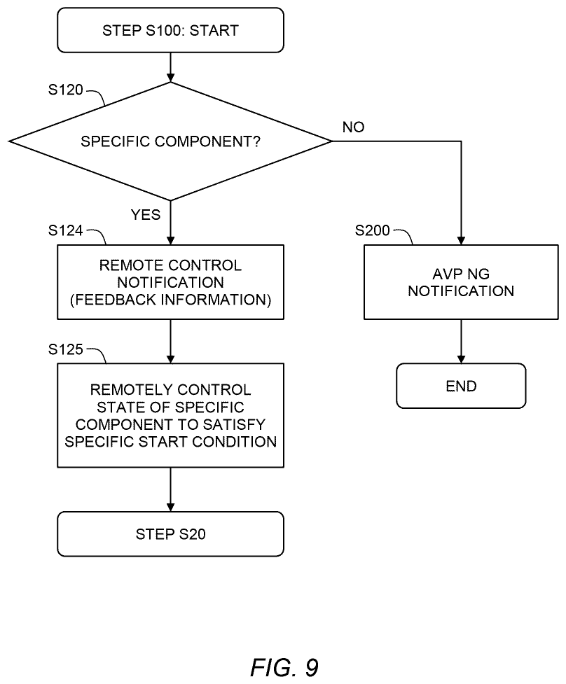

FIG. 9 is a flowchart showing a first example of the processing related to the vehicle state remote control in Step S100.

In Step S120, the back-end system 300 determines whether or not there is any specific component that does not satisfy the specific start condition. In other words, the back-end system 300 determines whether the state of the specific component does not satisfy the specific start condition. In still other words, the back-end system 300 determines whether or not the specific start condition can be satisfied by remotely controlling the state of the specific component. When there is any specific component that does not satisfy the specific start condition (Step S120; Yes), the processing proceeds to Step S124.

In Step S124, the back-end system 300 notifies the user of a remote control notification indicating that the state of the specific component is to be remotely controlled. More specifically, the back-end system 300 communicates with the user terminal 200 and transmits the remote control notification to the user terminal 200. The user terminal 200 presents the remote control notification received from the back-end system 300 to the user. Examples of the remote control notification include “door will be automatically closed”, “window will be automatically closed”, and the like. Such the remote control notification is a kind of the feedback information INF described above. Based on the remote control notification (the feedback information INF), the user can recognize that the check target vehicle state is going to satisfy the AVP start condition. This reduces the user's sense of anxiety or impatience. It should be noted that Step S124 may be omitted.

In Step S125, the back-end system 30 remotely controls the state of the specific component so as to satisfy the specific start condition. This increases the possibility that the check target vehicle state of the vehicle 100 satisfies the AVP start condition. After Step S125, the processing returns to Step S20 described above.

On the other hand, when the AVP start condition cannot be satisfied by the vehicle state remote control (Step S120; No), the processing proceeds to the above-described Step S200 (AVP NG notification). As a modification example, when the AVP start condition cannot be satisfied by the vehicle state remote control (Step S120; No), the processing may proceed to Step S110 shown in FIG. 7.

### 3-2-2. Second Example

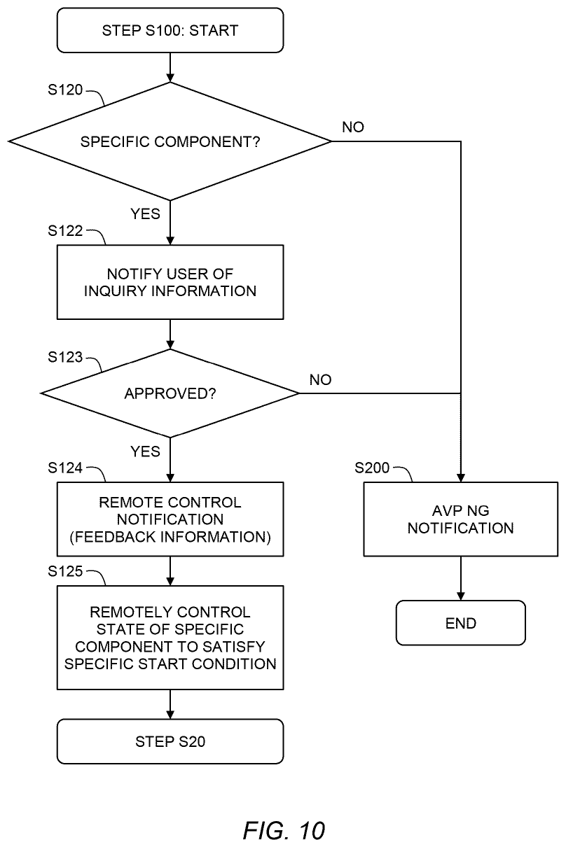

FIG. 10 is a flowchart showing a second example of the processing related to the vehicle state remote control in Step S100. The description overlapping with the first example described above will be omitted as appropriate.

When there is any specific component that does not satisfy the specific start condition (Step S120; Yes), the processing proceeds to Step S122. In Step S122, the back-end system 300 notifies the user of inquiry information. The inquiry information proposes, to the user, to remotely control the state of the specific component in order to satisfy the specific start condition. Such the inquiry information is a kind of the feedback information INF described above. The user can promote the AVP start by approving the remote control in response to the inquiry information. This reduces the user's sense of anxiety or impatience.

The user operates the user terminal 200 to approve or reject the remote control of the state of the specific component. The user terminal 200 transmits response information input by the user to the back-end system 300. The back-end system 300 determines whether the user has approved or rejected the remote control.

When the user approves the remote control (Step S123; Yes), the processing proceeds to Step S124 and Step S125 described above. This increases the possibility that the check target vehicle state of the vehicle 100 satisfies the AVP start condition. Accordingly, the user's sense of anxiety or impatience is reduced.

On the other hand, when the user rejects the remote control (Step S123; No), the processing proceeds to the above-described Step S200 (AVP NG notification). As a modification example, when the user rejects the remote control (Step S123; No), the processing may proceed to Step S110 shown in FIG. 7.

### 3-2-3. Third Example

The specific component that is remotely controllable may be classified into a first specific component and a second specific component. The vehicle state remote control may proceed in different manners depending on whether the specific component is the first specific component or the second specific component.

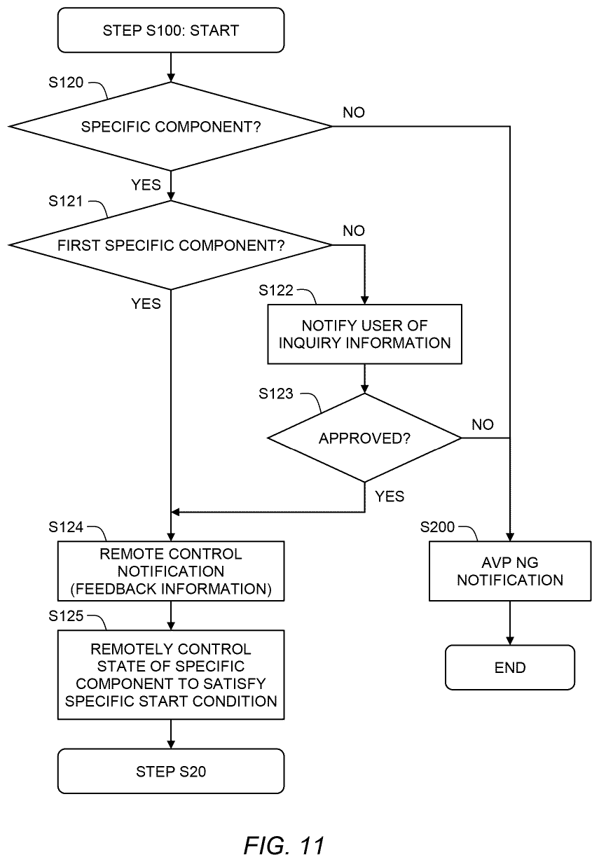

FIG. 11 is a flowchart showing a third example of the processing related to the vehicle state remote control in Step S100. The description overlapping with the first example or the second example described above will be omitted as appropriate.

When there is any specific component that does not satisfy the specific start condition (Step S120; Yes), the processing proceeds to Step S121.

When the specific component is the first specific component (Step S121; Yes), the processing proceeds to Step S124. This is the same as the case in the first example described above. That is, the back-end system 30 automatically remotely controls the state of the specific component so as to satisfy the specific start condition.

On the other hand, when the specific component is the second specific component (Step S121; No), the processing proceeds to Step S122. This is the same as the case in the second example described above. That is, the back-end system 30 remotely controls the state of the specific component so as to satisfy the specific start condition, with approval of the user.

For example, the second specific component is a movable member that may come into contact with the user. For example, the second specific component includes at least one of a door, a window, and a hood. The first specific component is a component (e.g., the power supply, a gear shift) other than the second specific component. The movable member is remotely controlled with approval of the user, which makes it possible to effectively prevent the user from coming into contact with the movable member.

### 3-3. Combination

A combination of the “feedback information notification” described in Section 3-1 and the “vehicle state remote control” described in Section 3-2 is also possible. For example, the vehicle state remote control is performed first. If the check target vehicle state does not satisfy the AVP start condition even after the vehicle state remote control is performed, the feedback information notification may be performed.

### 4. CONFIGURATION EXAMPLE OF VEHICLE

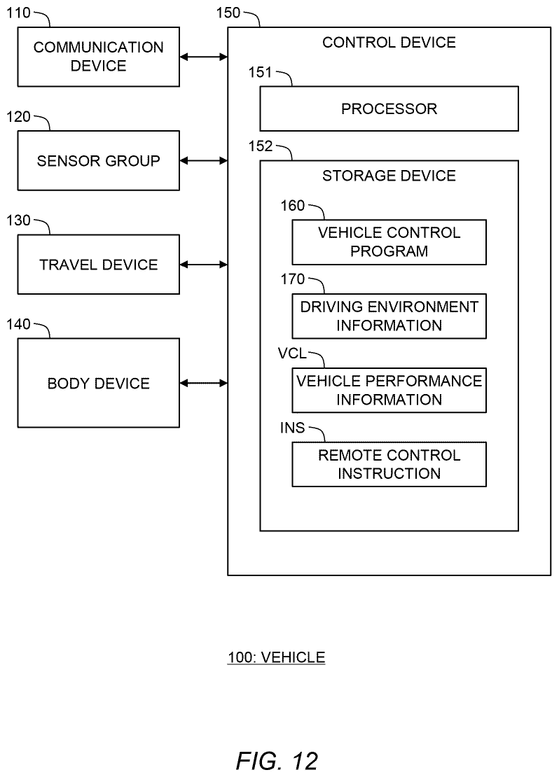

FIG. 12 is a block diagram showing a configuration example of the vehicle 100 according to the present embodiment. The vehicle 100 includes a communication device 110, a sensor group 120, a travel device 130, a body device 140, and a control device 150.

The communication device 110 includes an antenna and a transmission/reception circuit.

The sensor group 120 includes a recognition sensor, a vehicle state sensor, and the like. The recognition sensor is used for recognizing (detecting) a situation around the vehicle 100. Examples of the recognition sensor include a camera, a laser imaging detection and ranging (LIDAR), a radar, and the like. The vehicle state sensor includes a speed sensor, an acceleration sensor, a yaw rate sensor, a steering angle sensor, and the like.

The travel device 130 includes a steering device, a driving device, and a braking device. The steering device turns wheels. For example, the steering device includes an electric power steering (EPS) device. The driving device is a power source that generates a driving force. Examples of the driving device include an engine, an electric motor, an in-wheel motor, and the like. The braking device generates a braking force.

The body device 140 includes a door, a window, a light, a mirror, a wiper, a hood (roof top), a gas lid, a charging lid, and the like. Examples of the light include a blinker (direction indicator), a headlight, a brake light, a fog light, and the like.

The control device 150 is a computer that controls the vehicle 100. The control device 150 includes one or more processors 151 (hereinafter, simply referred to as a processor 151) and one or more storage devices 152 (hereinafter, simply referred to as a storage device 152). The processor 151 executes a variety of processing. Examples of the processor 151 include a general-purpose processor, a special-purpose processor, a central processing unit (CPU), a graphics processing unit (GPU), an application specific integrated circuit (ASIC), a field-programmable gate array (FPGA), an integrated circuit, and / or a combination thereof. The processor 151 may also be referred to as processing circuitry. The storage device 152 stores a variety of information. Examples of the storage device 152 include a volatile memory, a nonvolatile memory, a hard disk drive (HDD), a solid state drive (SSD), and the like.

A vehicle control program 160 is a computer program for controlling the vehicle 100. The functions of the control device 150 may be realized by a cooperation between the processor 151 executing the vehicle control program 160 and the storage device 152. The vehicle control program 160 is stored in the storage device 152. Alternatively, the vehicle control program 160 may be recorded on a non-transitory computer-readable recording medium.

The control device 150 communicates with the back-end system 300 and the parking lot system 400 via the communication device 110.

The control device 150 executes vehicle travel control for controlling travel of the vehicle 100. The vehicle travel control includes steering control, acceleration control, and deceleration control. The control device 150 executes the vehicle travel control by controlling the travel device 130 (i.e., the steering device, the driving device, and the braking device).

In addition, the control device 150 controls the body device 140. For example, the control device 150 automatically opens and closes the door. As another example, the control device 150 automatically opens and closes the window. As still another example, the control device 150 ON/OFF controls the light.

Moreover, the control device 150 acquires driving environment information 170 indicating a driving environment for the vehicle 100. The driving environment information 170 is stored in the storage device 152. For example, the driving environment information 170 includes surrounding situation information, vehicle state information, map information, position information, and the like.

The surrounding situation information indicates the result of recognition by the recognition sensor. The surrounding situation information may include object information regarding an object recognized by the recognition sensor. Examples of the object around the vehicle 100 include an obstacle, a white line, a marker M, and the like. Examples of the obstacle include a wall, a pillar, another vehicle, and the like. The object information indicates a relative position and a relative speed of the object with respect to the vehicle 100.

The vehicle state information indicates the vehicle state detected by the vehicle state sensor. Examples of the vehicle state include a speed, an acceleration, a yaw rate, a steering angle, and the like.

The map information is map information of the parking lot in which the vehicle 100 travels. The map information indicates an arrangement of roads in the parking lot. In addition, the map information indicates an arrangement of stationary obstacles (for example, walls and pillars) in the parking lot. The map information further indicates an arrangement of the markers M in the parking lot. For example, the map information is provided from the parking lot system 400 that manages the parking lot. The control device 150 acquires the map information from the parking lot system 400.

The position information indicates a current position of the vehicle 100 in the parking lot. For example, the control device 150 acquires the position information with high accuracy by performing localization processing (localization). More specifically, the control device 150 calculates a rough position of the vehicle 100 in the parking lot based on the vehicle state information (specifically, the steering angle and the speed). Moreover, the control device 150 recognizes the marker M around the vehicle 100 by using the recognition sensor. In addition, the control device 150 acquires the arrangement information of the markers M around the vehicle 100 from the map information. The control device 150 corrects the position of the vehicle 100 by matching the recognition result of the marker M with the arrangement of the markers M. Accordingly, the position information with high accuracy is obtained.

Alternatively, the position information of the vehicle 100 may be estimated by the parking lot system 400 based on the image captured by the infrastructure camera CAM. In this case, the control device 150 may acquire the position information from the parking lot system 400.

Further, the control device 150 acquires information on the travel path TP in the parking lot. For example, the travel path TP is determined by the parking lot system 400, and the control device 150 acquires information on the travel path TP from the parking lot system 400. As another example, the control device 150 may determine the travel path TP based on the map information and the position information. Then, the control device 150 executes the vehicle travel control based on the position information such that the vehicle 100 travels along the travel path TP.

The control device 150 provides information on the check target vehicle state of the vehicle 100 to the back-end system 300 via the communication device 110.

The vehicle performance information VCL indicates the vehicle type of the vehicle 100 or the specific component of the vehicle 100. The vehicle performance information VCL is stored in the storage device 152. The control device 150 may provide the vehicle performance information VCL to the back-end system 300 via the communication device 110.

The control device 150 may receive the remote control instruction INS from the back-end system 300 via the communication device 110. The remote control instruction INS instructs to control the state of the specific component so as to satisfy the specific start condition. In accordance with the remote control instruction INS, the control device 150 controls the power supply and the body device 140 so that the state of the specific component satisfies the specific start condition.

### 5. CONFIGURATION EXAMPLE OF USER TERMINAL

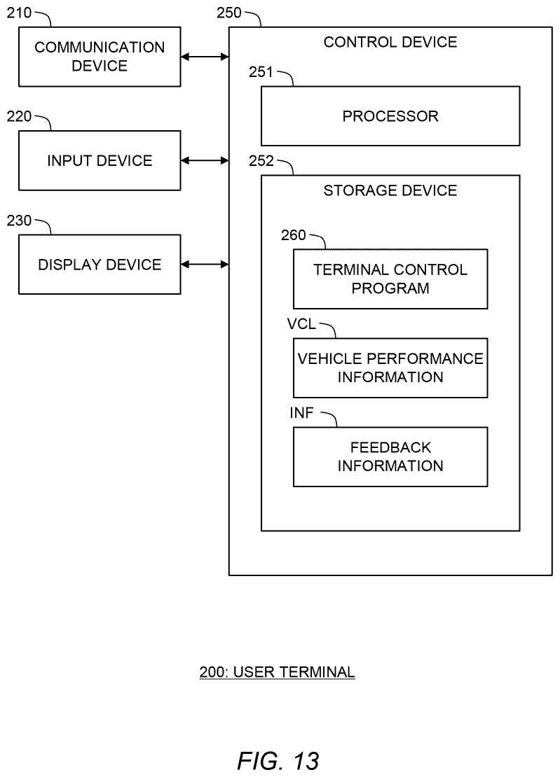

FIG. 13 is a block diagram showing a configuration example of the user terminal 200 according to the present embodiment. The user terminal 200 includes a communication device 210, an input device 220, a display device 230, and a control device 250.

The communication device 210 communicates with the outside via a communication network. For example, the communication device 210 communicates with the back-end system 300.

Examples of the input device 220 include a touch panel, a button, a microphone, and the like.

Examples of the display device 230 include a touch panel, a display, and the like. The display device 230 and the input device 220 may be the same touch panel.

The control device 250 is a computer that controls the user terminal 200. The control device 250 includes one or more processors 251 (hereinafter, simply referred to as a processor 251) and one or more storage devices 252 (hereinafter, simply referred to as a storage device 252). The processor 251 executes a variety of processing. Examples of the processor 251 include a general purpose processor, a special purpose processor, a CPU, a GPU, an ASIC, an FPGA, an integrated circuit, and / or combinations thereof. The processor 251 may also be referred to as processing circuitry. The storage device 252 stores a variety of information. Examples of the storage device 252 include a volatile memory, a nonvolatile memory, an HDD, an SSD, and the like.

A terminal control program 260 is a computer program for controlling the user terminal 200. The terminal control program 260 includes an AVP application. The functions of the control device 250 may be realized by a cooperation between the processor 251 executing the terminal control program 260 and the storage device 252. The terminal control program 260 is stored in the storage device 252. Alternatively, the terminal control program 260 may be recorded on a non-transitory computer-readable recording medium.

The control device 250 communicates with the back-end system 300 via the communication device 210.

The user is able to input a request regarding the AVP by the use of the input device 220. For example, the user can input the AVP start request. For example, the input device 220 and the display device 230 are configured by a touch panel. At the entry area, the user opens an AVP application. An “AVP Start” button is displayed on the touch panel. When the user taps the “AVP Start” button, the AVP start request is generated. The control device 250 transmits the AVP start request to the back-end system 300 via the communication device 210.

The vehicle performance information VCL (the vehicle type information) is stored in the storage device 252. The control device 250 may provide the vehicle performance information VCL to the back-end system 300 via the communication device 210.

The control device 250 may receive the feedback information INF from the back-end system 300 via the communication device 210. The control device 250 is able to present the feedback information INF to the user by displaying the feedback information INF on the display device 230.

The control device 250 may receive the inquiry information from the back-end system 300 via the communication device 210. The control device 250 is able to present the inquiry information to the user by displaying the inquiry information on the display device 230. In addition, the control device 250 acquires a user response (approval/refusal) to the inquiry information via the input device 220. The control device 250 transmits information of the user response to the back-end system 300 via the communication device 210.

### 6. CONFIGURATION EXAMPLE OF BACKEND SYSTEM

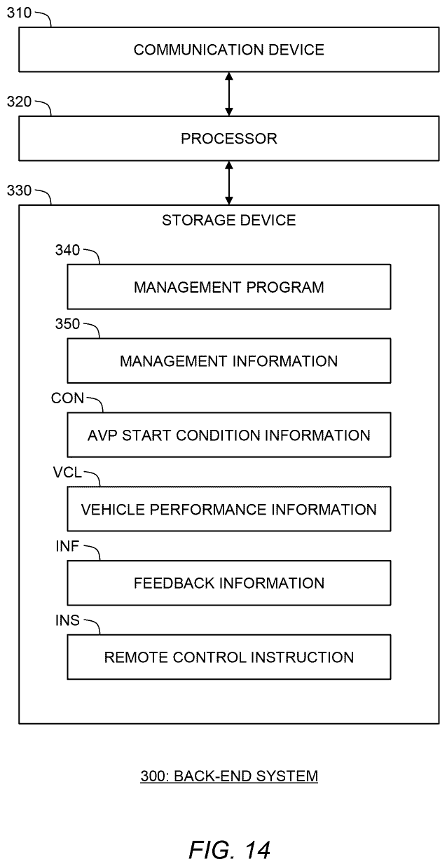

FIG. 14 is a block diagram showing a configuration example of the back-end system 300 according to the present embodiment. The back-end system 300 includes a communication device 310, one or more processors 320 (hereinafter simply referred to as a processor 320), and one or more storage devices 330 (hereinafter simply referred to as a storage device 330).

The communication device 310 communicates with each vehicle 100. In addition, the communication device 310 communicates with the user terminal 200 of each user. Further, the communication device 310 communicates with the parking lot system 400 of each parking lot.

The processor 320 executes a variety of processing. Examples of the processor 320 include a general purpose processor, a special purpose processor, a CPU, a GPU, an ASIC, an FPGA, an integrated circuit, and / or combinations thereof. The processor 320 may also be referred to as processing circuitry. The storage device 330 stores a variety of information. Examples of the storage device 330 include a volatile memory, a nonvolatile memory, an HDD, an SSD, and the like.

A management program 340 is a computer program for managing the AVP in the parking lot. The functions of the back-end system 300 may be realized by a cooperation between the processor 320 executing the management program 340 and the storage device 330. The management program 340 is stored in the storage device 330. The management program 340 may be recorded on a non-transitory computer-readable recording medium.

The processor 320 communicates with the vehicle 100, the user terminal 200, and the parking lot system 400 via the communication device 310.

The storage device 330 stores management information 350. The management information 350 may include the user information and the reservation information regarding each user. The management information 350 may include facility information and reservation status information regarding each parking lot. When the processor 320 receives the reservation request information from the user, the processor 102 may perform a reservation process based on the management information 350.

The storage device 330 further stores AVP start condition information. The AVP start condition information indicates the AVP start condition that is predetermined.

The storage device 330 may store the vehicle performance information VCL. For example, the vehicle performance information VCL is provided from the vehicle 100. As another example, the vehicle performance information VCL may be provided from the user terminal 200. The processor 320 stores the vehicle performance information VCL in the storage device 330. The processor 320 is able to recognize the specific component of the vehicle 100 based on the vehicle performance information VCL.

The processor 320 receives the AVP start request from the user terminal 200 via the communication device 310. Upon receiving the AVP start request, the processor 320 acquires the information on the check target vehicle state from vehicle 100 via communication device 310. The processor 320 checks whether or not the check target vehicle state satisfies the AVP start condition.

When the check target vehicle state does not satisfy the AVP start condition, the processor 320 may generate the feedback information INF regarding the check target vehicle state. The processor 320 transmits the feedback information INF to the user terminal 200 via the communication device 310.

When the check target vehicle state does not satisfy the AVP start condition, the processor 320 may generate the remote control instruction INS. The remote control instruction INS instructs to control the state of the specific component so as to satisfy the specific start condition. The processor 320 transmits the remote control instruction INS to the vehicle 100 via the communication device 310.

When the check target vehicle state does not satisfy the AVP start condition, the processor 320 may generate the inquiry information. The inquiry information proposes, to the user, remotely controlling the state of the specific component in order to satisfy the specific start condition. The processor 320 transmits the inquiry information to the user terminal 200 via the communication device 310.

What is claimed is:

1. A management system that manages automated valet parking of a vehicle in a parking lot,
the management system comprising processing circuitry, wherein the processing circuitry is configured to:
upon receiving a request to start the automated valet parking of the vehicle from a user of the vehicle, check whether or not a state of the vehicle satisfies a start condition that permits the automated valet parking to start; and
notify the user of feedback information regarding the state of the vehicle when the state of the vehicle does not satisfy the start condition.

2. The management system according to claim 1, wherein
the feedback information includes information indicating how the state of the vehicle does not satisfy the start condition.

3. The management system according to claim 1, wherein
the feedback information includes information indicating how to change the state of the vehicle to satisfy the start condition.

4. The management system according to claim 1, wherein
the vehicle has a specific component whose state is remotely controllable, and
the start condition includes a specific start condition that the state of the specific component is required to satisfy for permitting the automated valet parking to start.

5. The management system according to claim 4, wherein
the processing circuitry is further configured to, when the state of the specific component does not satisfy the specific start condition, automatically remotely control the state of the specific component to satisfy the specific start condition, and
the feedback information includes a remote control notification notifying that the state of the specific component is remotely controlled.

6. The management system according to claim 4, wherein
the processing circuitry is further configured to, when the state of the specific component does not satisfy the specific start condition, notify the user of inquiry information that proposes to remotely control the state of the specific component in order to satisfy the specific start condition, and
the feedback information includes the inquiry information.

7. The management system according to claim 6, wherein
the processing circuitry is further configured to, when the user approves remote control of the state of the specific component, remotely control the state of the specific component so as to satisfy the specific start condition, and
the feedback information further includes a remote control notification notifying that the state of the specific component is remotely controlled.

8. A management system that manages automated valet parking of a vehicle in a parking lot,
the management system comprising processing circuitry, wherein the processing circuitry is configured to, upon receiving a request to start the automated valet parking of the vehicle from a user of the vehicle, check whether or not a state of the vehicle satisfies a start condition that permits the automated valet parking to start,
the vehicle has a specific component whose state is remotely controllable,
the start condition includes a specific start condition that the state of the specific component is required to satisfy for permitting the automated valet parking to start, and
the processing circuitry is further configured to, when the state of the specific component does not satisfy the specific start condition, remotely control the state of the specific component to satisfy the specific start condition, automatically or with approval of the user.

9. The management system according to claim 8, wherein
the processing circuitry is further configured to:
when the state of the specific component does not satisfy the specific start condition, notify the user of inquiry information that proposes to remotely control the state of the specific component in order to satisfy the specific start condition; and
when the user approves remote control of the state of the specific component, remotely control the state of the specific component so as to satisfy the specific start condition.

10. The management system according to claim 8, wherein
the processing circuitry is further configured to:
in a case where the state of the specific component does not satisfy the specific start condition and the specific component is a first specific component, automatically remotely control the state of the specific component to satisfy the specific start condition; and
in another case where the state of the specific component does not satisfy the specific start condition and the specific component is a second specific component, remotely control the state of the specific component to satisfy the specific start condition with approval of the user.

11. The management system according to claim 10, wherein
the second specific component includes at least one of a door, a window, and a hood, and
the first specific component is other than the second specific component.

12. The management system according to claim 8, wherein
the processing circuitry is further configured to:
acquire vehicle performance information indicating a vehicle type of the vehicle or the specific component of the vehicle, and
recognize the specific component of the vehicle based on the vehicle performance information.
